(19) United States
(12) Patent Application Publication
(10) Pub. No.: US 2003/0098923 A1
(43) Pub. Date: May 29, 2003

(54) Installation/removal tool for night vision camera

(75) Inventor: Mark A. Matko, North Olmsted, OH (US)

Correspondence Address: Leonard L Lewis, Calfee, Halter & Griswold LLP, 800 Superior Avenue, Suite 1400, Cleveland, OH, 44114-2688, US

(73) Assignee: Honeywell Commercial Vehicle Systems Company

(21) Appl. No.: 09/996,152

(22) Filed: Nov. 28, 2001

(51) Int. Cl. H04N 5/225

(52) U.S. Cl. 348/375

(57) ABSTRACT

An installation/removal tool is provided for a night vision camera. An elongated handle includes a tool head at one end having drive recesses that mate with drive lugs on a nut of the aiming assembly. The tool is a simple design that is incorporated in a retrofit or aftermarket night vision system kit for the end user and allows the nut to be easily turned without damage for installing/removing the camera to the aiming assembly.

### BACKGROUND OF THE INVENTION

This application relates to a night vision system, and more particularly to a tool for an aiming assembly associated with a night vision camera.

A recent development in heavy vehicles such as tractor trailers, trucks, and the like is the use of a night vision system to assist in viewing the road during nighttime hours or inclement weather. A camera is mounted or installed in a vehicle or truck cab (where there is an unobstructed view of the road), preferably at a location that does not detract from the aesthetics of the vehicle and is protected from the elements. Moreover, it is desirable to have the camera located in an area where it is accessible for servicing, adjustment, etc.

By way of example only, it has been proposed to mount a night vision camera where the lens or opening faces forwardly from the cab. One suggested location is in an overhead storage compartment above the windshield that provides an unobstructed view of the road. The view of the road is similar to that of the driver from behind the steering wheel. It will be appreciated, however, that truck cabs of different makes and models will result in different mounting locations or orientations of the camera in the truck cab. Accordingly, an aiming assembly is provided that extends between the mounting surface and the camera and allows for selective angular adjustment of the camera to position the camera at the desired angle.

A conventional aiming assembly is a compact right angle adjustment arrangement that has a first shaft having a first end that operatively engages the night vision camera. The second end is received in the housing and cooperates with a second shaft through a right angle drive arrangement. A second end of the second shaft includes a uniquely configured nut that has first and second tabs or lugs diametrically opposed from one another. The nut is mounted for pivoting movement on the second shaft and must be rotated through ninety degrees (90°) between locked and unlocked positions. The nut is difficult to rotate manually. Moreover, the nut is typically formed of a plastic material and is easily damaged if a grasping tool, such as a pair of pliers, is used. The unique shape of the nut results in difficulty in rotating the nut of the aiming assembly during installation and removal of the night vision camera. Likewise, since the plastic nut can be easily damaged, it becomes more difficult to operate if repeatedly installed, removed, or adjusted.

Accordingly, a need exists for an improved tool that provides for easy locking and unlocking. It is also desirable that the tool be ergonomically designed to rotate the nut without damage during operation, easy to manufacture and also have a conformation that can be easily grasped and operated by a user.

### SUMMARY OF THE INVENTION

A new and improved installation/removal tool for a night vision camera is provided.

The tool includes a handle dimensioned for receipt in a user's hand and has a tool at one end configured for mating engagement with a nut on a shaft of an aiming assembly.

The handle is preferably elongated to allow a user to easily grasp and operate, i.e., apply the desired torque to the nut on the shaft.

At one end of the elongated handle is a tool head having first and second clearances or grooves formed diametrically opposite one another. The grooves are dimensioned to closely receive the drive lugs associated with the nut on the shaft of the aiming assembly. A central recess in the tool head is dimensioned for sliding receipt over a substantially cylindrical portion of the nut and provides a total capture or encapsulation about the nut as torque is applied through the handle.

The tool provides for ease of installation and removal of the night vision camera.

The tool is easily manufactured and has an ergonomic design that allows for selective rotation of the nut without damage.

Still other features and benefits of the present invention will become apparent to those skilled in the art upon reading and understanding the following detailed description.

### BRIEF DESCRIPTION OF THE DRAWINGS

FIG. 1 is an isometric view of a preferred form of aiming assembly used in association with a night vision camera.

FIG. 2 is an elevation view thereof.

FIG. 3 is an overhead plan view of the aiming assembly of FIG. 2.

FIG. 4 is an elevational view taken from the right-hand end of FIG. 2.

FIG. 5 is an elevational view of a preferred embodiment of the adjuster tool.

FIG. 6 is an end view taken generally from the left-hand side of FIG. 5.

### DETAILED DESCRIPTION OF THE PREFERRED EMBODIMENTS

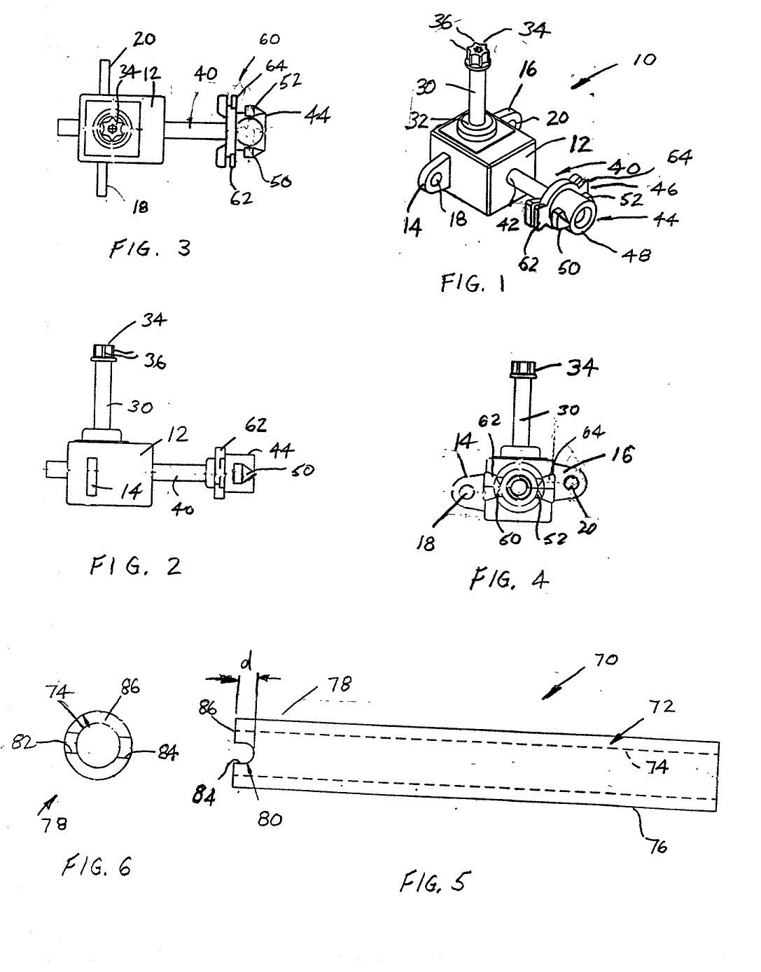

FIG. 1 illustrates an aiming assembly 10 as conventionally used with a night vision camera (not shown) of a night vision system. Typically, the camera is mounted to multiple adjustment or aiming assemblies of this type to allow selective pivoting of the camera about two perpendicular axes. Thus, the aiming axis or focal direction of the camera can be selectively oriented about the two axes by selectively advancing and retracting, i.e., altering, the adjustment assemblies. Particularly, the adjustment assembly 10 includes a housing 12, shown here as a parallelepiped structure. The housing has first and second flanges 14, 16 with openings 18, 20 that receive a fastener (not shown) for securing the adjustment assembly to a mounting surface (not shown). Extending outwardly from one face of the housing is a first shaft 30. A first end 32 of the first shaft extends into the housing. Although not visible in FIG. 1, the first end 32 includes a gear or thread that cooperates with a mating gear or thread to advance and retract the camera.

A second or outer distal end 34 of the first shaft has a unique configuration in which circumferentially spaced lobes 36 define drive surfaces or drive members, and similarly encloses a recess 36′ that has similarly shaped recesses defining drive surfaces. Here, six drive surfaces are provided on the second end, although it will be appreciated that a greater or lesser number, or different style of drive surface, can be used without departing from the scope and intent of the invention. As will be described in greater detail below, the distal end is selectively rotated to adjust the position of the camera

A second shaft 40 extends outwardly from the housing along a face of the housing that is perpendicular to the face from which the first shaft extends. The second shaft includes a first or inner end 42 received in the housing for operative engagement with the first end of the first shaft. Again, a gear or threaded end provides for a preselected ratio, right angle gear drive. Thus, rotation of the input shaft 40 results in selective advancement and retraction of the second shaft 30 relative to the housing A second or outer end 44 of the input shaft includes a uniquely configured nut 46. The nut has a smooth-walled, substantially cylindrical portion 48 from which extend first and second tabs or lugs 50, 52. Spaced axially inward is a shoulder 60 having radially outward extending mounting flanges 62, 64 that are dimensioned for locking engagement with the camera and also define a stop surface, as will become more apparent below.

The aiming assembly is secured to a mounting surface via fasteners through the retaining lugs 14, 16. A night vision camera is then operatively secured to the mounting flanges located adjacent the second end of the second shaft 30. Selective rotation of the nut 44 provided on the input shaft 40 provides for locking engagement with the camera, typically by rotating the nut relative to the second shaft through approximately ninety degrees (90°). The nut is pivotally mounted on the second shaft, however, it is difficult to rotate the nut relative to the shaft.

A preferred tool that cooperates with the nut on the aiming assembly is more particularly illustrated in FIGS. 5 and 6. The tool 70 has an elongated handle portion 72, shown here as a hollow cylindrical member, having an inner diameter 74 and an outer diameter or external surface 76. Although not necessary, for ease of manufacturing, the opening 74 extends through the entire length of the elongated handle. Likewise, the external surface 76 is shown as a smooth-walled surface for ease of manufacture, although it will be understood that the handle may include a ribbed or knurled surface or similar anti-slip surface that allows the user's hand to firmly grip and engage the tool handle.

At one end 78 of the handle is provided a tool head 80. The tool head is dimensioned for close fitting engagement with the nut. More particularly, the opening 74 is slightly larger than the cylindrical portion 48 of the nut. This allows the tool to be axially advanced over the nut until the tool head engages the mounting flanges 62, 64 that act as a stop surface. In addition, drive recesses 82, 84 extend radially outward from the central opening 74 in the tool. The drive recesses are dimensioned for mating receipt over the drive lugs 50, 52 on the nut. As will also be appreciated, the axial depth, i.e., the dimension d as shown in FIG. 5 closely corresponds to the axial depth of the drive lugs on the nut. Thus, end face 86 engages the mounting flanges 62, 64 when the drive recesses 82, 84 are properly oriented over the drive lugs of the nut. In this manner, rotation of the handle transfers a torque to the tool head and nut to provide for selective locking and unlocking of the nut on the associated camera.

The invention has been described with reference to the preferred embodiment. Obviously, modifications and alterations will occur to others upon reading and understanding the preceding detailed description. It is intended that the invention be construed as including all such modifications and alterations in so far as they come within the scope of the appended claims or the equivalents thereof.

Having thus described the present invention, it is now claimed:

1. A tool for an aiming assembly operatively engaging a night vision camera, the tool comprising:
a handle dimensioned for receipt in an associated user's hand; and
a tool head positioned at one end of the handle, the tool head having circular first and second drive means disposed on substantially diametrically opposite sides of the tool head for selective engagement with associated drive lugs of an aiming assembly.

2. The tool of claim 1 wherein the handle has a hollow cylindrical conformation.

3. The tool of claim 2 wherein the handle has a smooth external surface.

4. The tool of claim 1 wherein the tool head has a circular recess extending inwardly from an end face at least a predetermined dimension to allow the tool head to be axially received over an associated nut when the first and second drive means are aligned with the associated drive lugs of the aiming assembly.

5. The tool of claim 4 wherein the tool head end face is planar.

6. The tool of claim 1 wherein the handle and tool head have a hollow cylindrical conformation defined by a through bore extending continuously therethrough.
